(19) United States
(12) Patent Application Publication
(10) Pub. No.: US 2016/0348826 A1
(43) Pub. Date: Dec. 1, 2016

(54) Methods for Reducing Fluid Loss in Fluid-Bearing Systems

(71) Applicants: Ryan Drollinger, Cora, NY (US); Keith C. Drollinger, Helper, UT (US)

(72) Inventors: Ryan Drollinger, Cora, NY (US); Keith C. Drollinger, Helper, UT (US)

(21) Appl. No.: 15/152,919

(22) Filed: May 12, 2016

Related U.S. Application Data
(63) Continuation of application No. 12/692,504, filed on Jan. 22, 2010, now abandoned.

(51) Int. Cl. F16L 55/11

(52) U.S. Cl. CPC F16L 55/1141

(57) ABSTRACT

A plug is made of a compressible and resilient material, and includes a tip and a base greater in diameter than the tip. The plug is configured so that the plug can be compressed and inserted tip first into an orifice exposed by disconnection of members of a fluid-bearing system such that the plug expands to seal the orifice when the plug is released. A handle is attached to the plug and extends from the base and is configured to facilitate removal of the plug from the orifice, the handle including a ring and being formed from the same material as is the plug.

### PRIORITY CLAIM

This is a continuation of U.S. patent application Ser. No. 12/692,504, filed Jan. 22, 2010, which is hereby incorporated herein by reference in its entirety.

### BACKGROUND

In fluid-bearing systems of many types, containment of the fluid can be a concern. Containment concerns can arise in fluid bearing systems in particular when parts of the system are lost or need to be replaced. In some cases, due to their location, the loss or replacement of fluid-bearing parts can involve either evacuating the system or dealing with significant spillage. In some cases, the fluid is harmful to health or otherwise poses a negative impact on safety or the environment. In other cases, loss of fluid negatively impacts performance of the system. In addition, the fluid may be costly to replace, making avoiding waste of the fluid an economic concern.

### SUMMARY

The present invention sets forth devices and methods for reducing fluid loss that can result from disconnections in fluid-bearing systems. According to an embodiment a plug can be made of a compressible and resilient material, so that the plug can be compressed and inserted tip first into an orifice exposed by disconnection of members of a fluid-bearing system, and the plug expands to seal the orifice when the plug is released. In another embodiment, a kit can include a plurality of such plugs, where the plurality includes at least two differently-sized plugs.

According to still another embodiment, a method for reducing fluid loss in a fluid-bearing system during repair includes using a plug made of a compressible and resilient material to seal an orifice in the fluid-bearing system, said orifice being exposed by a disconnection of members of the fluid-bearing system. The orifice can be smaller in diameter than the base of the plug. The method includes compressing the plug sufficiently so that at least the tip of the plug fits into the orifice, inserting the tip into the orifice, and then releasing the plug so that the plug expands to seal the orifice.

In one aspect, a kit for reducing fluid loss from fluid-bearing systems is provided. The kit can include a plurality of plugs made of a compressible and resilient material, each plug comprising a tip and a base greater in diameter than the tip, and configured so that the plug can be compressed and inserted tip first into an orifice exposed by disconnection of members of a fluid-bearing system, and the plug expands to seal the orifice when the plug is released, and wherein at least two plugs differ in diameter.

### BRIEF DESCRIPTION OF THE DRAWINGS

FIG. 1 is a top perspective view of a plug exhibiting a conical profile in accordance with an embodiment of the present invention;

FIG. 2 is a top perspective view of a plug exhibiting an conical profile in accordance with another embodiment;

FIG. 3 is a top perspective view of a plug exhibiting a bell-shaped profile in accordance with an embodiment;

FIG. 4 is a perspective view of an inverted plug as shown in FIG. 1B that includes a handle in accordance with an embodiment;

FIG. 5 is a perspective view of an inverted plug as shown in FIG. 1B that includes a cord handle in accordance with another embodiment;

FIG. 6 is a cross-sectional view of the process of sealing a hose with plug in accordance with an embodiment; and

FIG. 7 is a perspective view of plugs in accordance with an embodiment installed in an automotive radiator.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “orifice” can include reference to one or more of such orifices.

As used herein, a plurality of items, structural elements, compositional elements, and/or materials may be presented in a common list for convenience. However, these lists should be construed as though each member of the list is individually identified as a separate and unique member. Thus, absent indications to the contrary, no individual member of such a list should be construed as a de facto equivalent of any other member of the same list based solely on their presentation in a common group.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 centimeters should be interpreted to include not only the explicitly recited values of about 50 centimeters and 250 centimeters, but also include individual values and sub-ranges within the indicated range. Thus, included in this numerical range are individual values such as 60, 70, and 80 centimeters, and sub-ranges such as from 50-100 centimeters, from 100-200, and from 100-250 centimeters, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not exact and need not be exact, but rather may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

As used herein the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

The term “fluid” as used herein refers particularly to substances in a liquid state, but can also refer to gases that are contained within a system and which can behave like liquid in some aspects.

As used herein, “fluid-bearing system” refers to any mechanical system that includes a part that holds or conveys fluid. This can apply to systems that are purposed for holding or conveying fluid, as well as systems directed to other purposes but the normal operation of which includes the presence or conveyance of fluid within one or more of the system's parts. Fluid-bearing systems to which the present invention is directed include, without limitation, hydraulic systems, cooling systems, heating systems, lubricating systems, plumbing systems, and fuel systems. “Fluid-bearing parts” or “fluid-bearing members” in such systems can include, without limitation, those that transport fluids, i.e. conduits, such as hoses, lines, tubes, pipes, and the like. Fluid-bearing members can also include members that hold and store fluids, i.e. reservoirs. Other fluid-bearing members as discussed herein can include members that impel, direct, or distribute fluids, such as pumps, manifolds, exchangers, and the like.

The term “resilient” refers generally to a material property by which the material is capable of recovering its size and shape after deformation, particularly deformation caused by compressive stress. The term can particularly be used to refer to materials having a high compression set resistance.

The present invention is directed to devices and methods for containing fluids in fluid-bearing systems. More particularly, devices and methods are disclosed for sealing openings by which fluid could enter or leave such systems. Such access points are generally referred to herein as orifices. These can include unintended breaches in a fluid-bearing system, such as ruptures or tears arising from damage or wear. However, orifices can also include openings that are included in the design of a system or its members but which are open due to disassembly of the system or absence of the usual means of sealing the openings (e.g., absence of a cap or lid intended for selective sealing of an opening). Some examples of such orifices include openings (such as fill holes) designed for introducing fluids to the system and where the stopper or cap that normally seals the hole is unavailable. One such example is when the gas cap of an engine fuel tank has been lost. When left un-remedied, this can result in fuel loss as well as escape of flammable vapors from the tank.

Another example of the creation of an orifice in a fluid-bearing system is the disconnection of one or more fluid-bearing members in the system. One illustrative example can arise from disconnecting a fluid-bearing hose such as a fuel line, coolant hose, or hydraulic line for purposes of repair or replacement. In such a case the fuel, coolant, or hydraulic fluid may spill out of the disconnected end and/or the structure to which the end was connected. This is of particular concern where operation of the system drives fluid through the hose, or where the hose is located in an area of the system where centrifugal forces or gravity would tend to accelerate fluid loss. In either case, significant or even total fluid loss could occur before the disconnection can be remedied.

In accordance with the embodiments of the present invention, a plug device can be used to seal an orifice in a fluid-bearing system, particularly during repair or maintenance of the system. In one embodiment, the plug can be made of a compressible and resilient material, thereby allowing the plug to deform enough to conform to the dimensions of the orifice. The plug can therefore be used by compressing the plug enough for insertion into the orifice to be sealed, and then releasing compression so that the plug substantially fills the orifice. Accordingly, the material used in the plug may be selected to provide a compressibility and resilience that is effective for such use. In one aspect, the material can be selected such that a plug made of the material can be compressed by hand or between a thumb and a finger. In another aspect, the material can be sufficiently resilient such that the plug assumes its previous shape after compression is released. Compressible and resilient materials are known to those skilled in the art, and include elastomeric materials such as polyurethane, polyester, polyether, polyvinylchloride, or silicone, natural rubber, sponge rubber, ethylene acrylic, epichlorohydrin, ethylene propylene rubber, isoprene rubber, nitrile rubber, hydrogenated nitrile rubber. In a particular aspect the plug is a substantially solid construct.

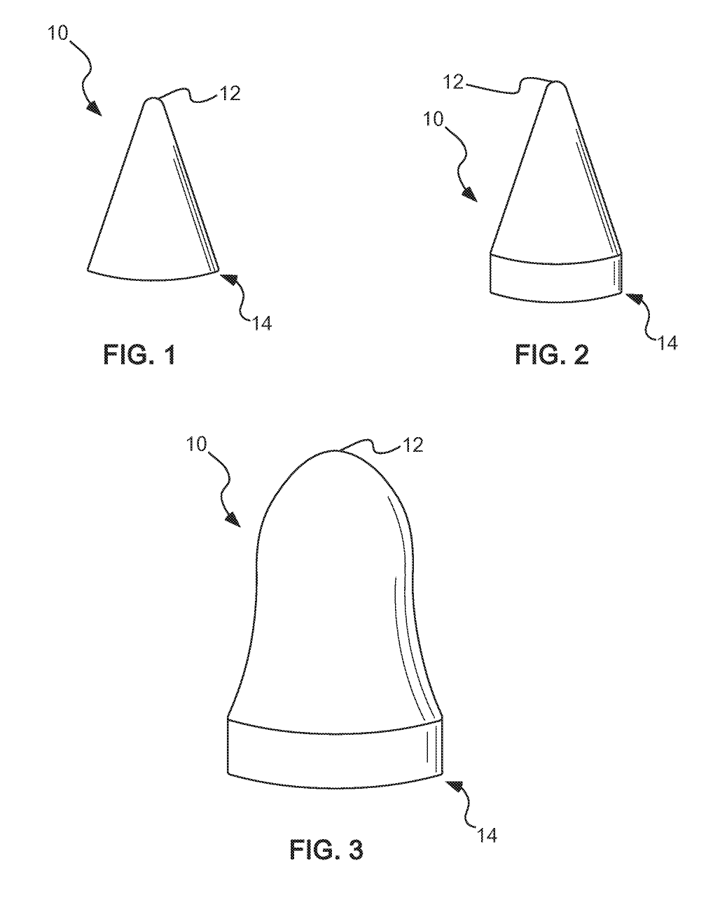

The plug can also have a shape and a size so as to facilitate insertion of the plug into an orifice. In a particular embodiment, the base of the plug can have a larger diameter than its tip. In a particular aspect, the plug can exhibit a degree of taper from its base to its tip so as to provide effective sealing for a range of orifice sizes. FIGS. 1 and 2 each show exemplary embodiments of the plug that exhibit profiles in accordance with this aspect. The tapered profile can occupy the entire length of the plug. FIG. 1 shows such an embodiment in which a plug 10 has a substantially conical profile from its tip 12 to its base 14. Alternatively, the taper can occupy some portion of the plug's length including the tip, as illustrated by the plugs shown in FIGS. 2 and 3. In another aspect, the taper can exhibit inflections. FIG. 3 shows such an embodiment in which the plug 10 exhibits a substantially bell-shaped profile.

The size of the plug can be selected to effectively seal orifices having a diameter within a particular range. The diameter range selected can be based upon the type of system in which the plug is to be used, or upon dimensions of the particular fluid-bearing components of the system. An exemplary diameter range can be from 12.70 mm (0.5 inches) to about 11.43 cm (4.5 inches). In tapered embodiments such as those exemplified in FIGS. 1 through 3, a particular base diameter may be selected based on the orifice in which it will be used. In accordance with the mode of operation described herein, the diameter of the plug at some point along its length can be larger than the diameter of the orifice to be sealed. In one embodiment, the base 14 has a diameter that is larger than the orifice. In one aspect, the base can be from 12.70 mm (0.5 inches) to about 15.24 cm (6 inches) in diameter. In a more particular aspect, the base can be from 6.35 cm to 8.89 cm (2.5 to 3.5 inches) in diameter. In an alternative aspect, the base can be from 12.70 mm to 38.10 mm (0.5 to 1.5 inches) in diameter.

The plug device of the present invention may include additional features designed to facilitate its function. For example, the plug device can include liquid resistance so as to prevent absorption of system fluid into the plug. In a particular embodiment, such a feature can be provided by a liquid-resistant material added to the plug. In a more particular embodiment, the liquid-resistant material can be present in the form of a coating applied to at least the tip of the plug. In another embodiment, the liquid-resistant material can impregnate and be integrated into the body of the plug, e.g. intermingled with the compressible material from which the plug is constructed. In one aspect, the liquid resistant material can also confer resistance to chemicals in the fluid. Any liquid-resistant materials that are known to be suitable for forming coatings or solid materials can be used for this purpose in the present invention, including latex rubber, polyethylenes, polyvinylchlorides, nitriles, polychloroprenes, and the like. In a specific embodiment, the liquid-resistant material is a latex rubber.

The plug of the present invention is capable of being inserted far enough into an orifice so that it fills the orifice to form an effective seal. It may be desirable to adjust the placement of the plug at some time during use or to remove the plug from the orifice after use. However, in some modes of use, the eventual placement of the plug may be such that it is no longer easily accessible. This can occur due to deep insertion of the plug when it is installed, or to the plug being pushed or pulled further into the orifice during use (e.g. due to negative pressure at the orifice).

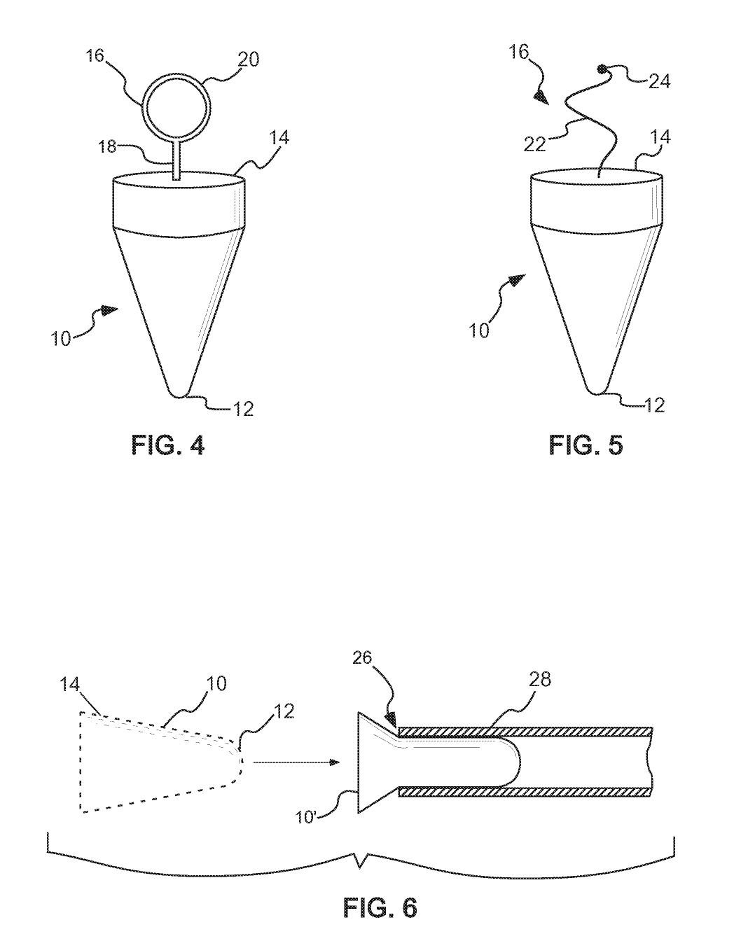

According to an embodiment of the invention, the plug device can include one or more features configured to facilitate placement, adjustment, or removal of the plug. Such a feature can include a handle that is securely attached to the plug and extends from the base of the plug. In one aspect, the handle is configured to be grasped or otherwise engaged so that it can be used to pull the plug from the orifice if desired. In a more particular aspect, the handle can be engaged by one or more fingers, so that the plug can be removed or adjusted without additional tools. The handle can comprise a flexible structure such as a cord or strand, or a more rigid structure such as a post. Rigidity can be provided by making the handle from a rigid material such as a hard plastic. In one aspect, a rigid handle can be used to insert the plug as well as remove it. In more specific embodiment, the handle can include a feature fixably attached thereto that facilitates engagement with the device. Exemplary features include a ring, a loop, a hook, or a knob. One exemplary embodiment of a plug which includes a handle 16 is shown in FIG. 4, where the handle comprises a post 18 with a ring 20 on its distal end. FIG. 5 shows another embodiment in which the handle 16 comprises a cord 22 with a knob 24 on its distal end to facilitate grasping and removing the plug. It should be understood that these combinations of features are exemplary, and any combination of handle features can be used that will serve the function described above. For example, a handle can be included with a plug having a different profile than illustrated in FIGS. 4 and 5. Similarly, different distal features can be utilized on each type of handle.

The present invention provides methods for reducing the loss of fluid from fluid-bearing systems by the use of plug devices such as those described here. In particular such methods can comprise plugging an orifice in a fluid-bearing system using a plug made of a compressible, resilient material. In one embodiment, the method can comprise compressing the plug sufficiently so that at least the tip end of the plug fits into the orifice, inserting the tip end into the orifice, and then releasing the plug so that the plug expands to seal the orifice. In a particular embodiment, the plug can include a handle by which the plug is removed. In a more particular aspect of this embodiment, the handle can be used to place the plug into the orifice.

The method can be used to plug orifices, including those occurring in fluid-bearing systems as discussed above. More particularly, fluid loss in fluid-bearing systems can be reduced using this method. Exemplary systems include, without limitation, fluid-bearing systems such as may be found in vehicles (such as vehicular engines, braking systems and control systems), buildings (such as plumbing systems and ventilation systems), or machines. Such systems can bear fluids such as coolant, fuel, lubricant, hydraulic fluids, potable fluids, wastes, and others that are known to be borne in systems such as described herein.

As discussed above, an orifice in such systems may be exposed by damage that disconnects members of the system, or may be created by deliberate disconnection of members. The methods of the present invention can be employed as part of repair or maintenance of fluid-bearing systems. For example, a fluid-bearing member (e.g. a hose) can be disconnected at one end from a second fluid-bearing member with which it communicates, and a plug can be inserted into that end to seal it and prevent fluid loss. An example of this use is illustrated in FIG. 6, where a plug 10 (shown in dashed lines) is compressed and its tip 12 is inserted into the open end 26 of a hose 28 (shown in section), thereby sealing the open end in accordance with the present invention. The plug is shown at 10′ in its partially expanded form filling the orifice. It should be noted that in such an operation, often two or more orifices may be considered to be opened, e.g. the end of the hose being the first and the second orifice in the member that served as the connection point for the hose. In alternate aspects of the method, a plug can be inserted into either one or both of the orifices to prevent escape of fluids.

It should also be noted that in accordance with these embodiments, the plug can be left in place indefinitely, or can be removed as desired. One example is the use of a plug to seal an orifice exposed by disconnecting members of a system. The plug may be left in place as a temporary measure to reduce fluid loss until the system can be reassembled. Alternatively, the plug can be an effective permanent means for sealing an orifice when reassembly of the system is not anticipated.

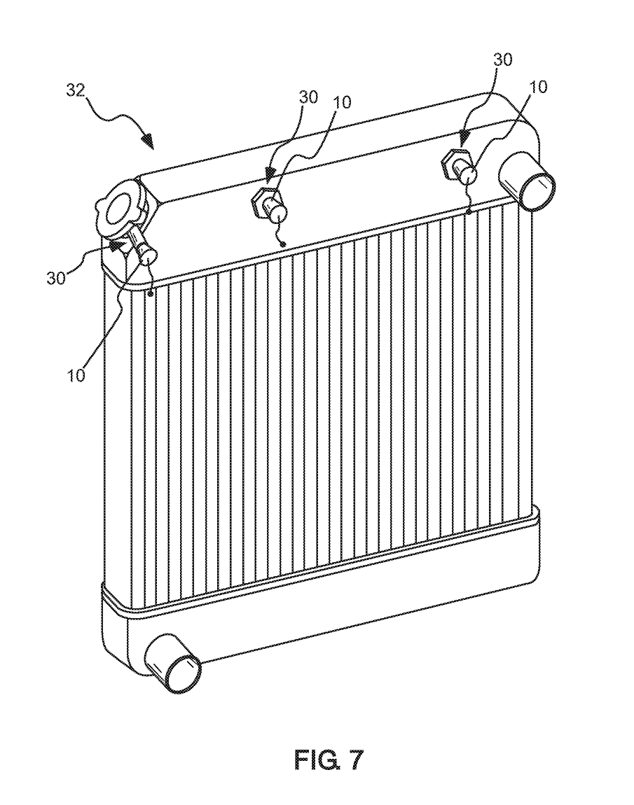

Another exemplary use in accordance with this principle is illustrated in FIG. 7, in which plugs 10 as described herein are used to seal the coolant ports 30 of an automotive radiator 32. As illustrated in the figure, the plug size or type utilized can be selected based upon the size or location of the orifice, and a plurality of sizes may therefore be used in the same system.

In another embodiment, a plug can be used to seal an orifice that is included in a fluid-bearing system to provide access thereto, such as a hole for adding or removing fluid from the system. In another aspect of these embodiments, the disconnected member can be one that is not fluid-bearing but would otherwise close an opening in a fluid-bearing member, such as a cap or plug.

In a particular embodiment, the present invention provides method of replacing fluid-bearing parts while reducing the escape of fluid from these or other parts in a system. In alternate embodiments, plugs of the present invention can be used to seal an orifice of an object so as to prevent entry of unwanted matter into said object. This can be useful during storage or transport of an object under conditions where moisture, dust, dirt, or plant or animal life may invade the object.

Plug devices in accordance with the present invention can serve as a means to quickly remedy containment breaches in fluid-bearing systems. Moreover, their portability and ease of use can make such plugs useful as in emergency breach situations or in remote locations where other means of repair may not be readily available. In an embodiment of the present invention a kit can comprise a plurality of plug devices as described herein. In one particular embodiment, the kit can include plugs of at least two different sizes. In one aspect, the plurality of sizes in a kit can be selected based on the orifice sizes that characterize a particular system. For example a kit suited for use with a passenger vehicle can include plugs of an assortment of sizes that encompass the sizes of the various lines, hoses, and fill holes specified for that make of vehicle. Similarly, a kit for a commercial tractor or a personal recreational vehicle would include a different assortment of sizes in accordance with the specifications of the vehicle. Such a kit can be packaged so it can be readily carried on the vehicle and therefore available for use at any time.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A plug made of a compressible and resilient material, having a tip and a base greater in diameter than the tip, and configured so that the plug can be compressed and inserted tip first into an orifice exposed by disconnection of members of a fluid-bearing system, and the plug expands to seal the orifice when the plug is released; and
a handle, attached to the plug and extending from the base and configured to facilitate removal of the plug from the orifice, the handle including a ring and being formed from the same material as is the plug.

2. The plug of claim 1, wherein the compressible and resilient material is selected from the group consisting of polyurethane, polyester, polyether, polyvinylchloride, or silicone, natural rubber, sponge rubber, ethylene acrylic, epichlorohydrin, ethylene propylene rubber, isoprene rubber, nitrile rubber, hydrogenated nitrile rubber, and combinations and mixtures thereof.

3. The plug of claim 1, wherein the base has a diameter of from about 0.5 inches to about 6.0 inches.

4. The plug of claim 3, wherein the base has a diameter of from about 2.0 inches to about 6.0 inches.

5. The plug of claim 1, further comprising a liquid-resistant material.

6. The plug of claim 5, wherein the liquid-resistant material is present as a coating on the plug.

7. A method of reducing loss of fluid from a fluid-bearing system during repair of said system using a plug made of a compressible and resilient material, the plug including a tip and a base, comprising:
locating an orifice in the fluid-bearing system, where said orifice is exposed by a disconnection of members of the fluid-bearing system, said orifice being smaller in diameter than a diameter of the base of the plug;
compressing the plug so that at least the tip of the plug, and some compressed portion of the plug, fits into the orifice;
inserting the plug into the orifice in a compressed state;
releasing the plug after insertion into the orifice so that the plug expands to seal the orifice; and
removing the plug from the orifice using a handle coupled to and extending from the base.

8. The method of claim 7, wherein one of the members is selected from the group consisting of conduit, reservoir, cap, pump, manifold, and exchanger.

9. The method of claim 8, wherein the orifice comprises an open end of a conduit.

10. The method of claim 8, wherein one of the members of the fluid-bearing system is a reservoir.

11. The method of claim 7, wherein the base has a diameter of from about 12.70 mm (0.5 inches) to about 15.24 cm (6 inches).

12. The method of claim 7, wherein the compressible and resilient material is selected from the group consisting of polyurethane, polyester, polyether, polyvinylchloride, or silicone, natural rubber, sponge rubber, ethylene acrylic, epichlorohydrin, ethylene propylene rubber, isoprene rubber, nitrile rubber, hydrogenated nitrile rubber, and combinations and mixtures thereof.

13. The method of claim 7, wherein the plug further includes a liquid-resistant material.

14. The method of claim 13, wherein the liquid-resistant material is present as a coating on the plug.

15. The method of claim 7, further comprising removing the plug from the orifice using a handle formed at least partially as a ring extending from the base, the handle being formed from the same material as is the plug.
